(19) United States
(12) Patent Application Publication
(10) Pub. No.: US 2014/0261321 A1
(43) Pub. Date: Sep. 18, 2014

(54) FUEL SYSTEM HAVING ROTARY DISTRIBUTOR

(71) Applicant: ELECTRO-MOTIVE DIESEL, INC., Lagrange, IL (US)

(72) Inventor: Rakesh MALHOTRA, Aurora, IL (US)

(73) Assignee: Electro-Motive Diesel, Inc., Lagrange, IL (US)

(21) Appl. No.: 13/799,618

(22) Filed: Mar. 13, 2013

(51) Int. Cl. F02M 61/14

(52) U.S. Cl. CPC F02M 61/14
USPC 123/445

(57) ABSTRACT

A fuel system is disclosed for use with an engine having a plurality of cylinders. The fuel system may have a fuel supply, and a fuel distributor configured to selectively connect the fuel supply with the plurality of cylinders. The fuel system may also have a fuel valve fluidly connected between the fuel supply and the fuel distributor. The fuel valve may be movable to affect a fueling parameter of individual cylinders of the plurality of cylinders.

### TECHNICAL FIELD

The present disclosure relates generally to a fuel system and, more particularly, to a fuel system having a rotary distributor.

### BACKGROUND

Many different systems exist for mixing fuel with air and for delivering the mixture into an engine's combustion chambers. For example, fuel can be directly injected into the combustion chamber as a liquid or a gas, or indirectly injected into an upstream air passage and allowed to mix with the air as the air enters the combustion chamber. In either situation, variability between fuel injectors can cause unstable engine operation. In addition, the number of fuel injectors used in conventional engines can be expensive and increase unreliability.

One attempt at improving engine operation is disclosed in U.S. Pat. No. 2,446,497 (the '497 patent) that issued to Thomas on Aug. 3, 1948. In particular, the '497 patent discloses a fuel injection apparatus for a multi-cylinder compression ignition engine. The fuel injection apparatus is of the common rail type, wherein a pump delivers liquid fuel under pressure to an accumulator common to all cylinders of the engine. The liquid fuel is then directed from the accumulator to the engine cylinders in proper sequence by a rotary distributing valve operating in synchronism with the engine.

Although the fuel injection apparatus of the '497 patent may help to reduce injector-to-injector variability, it may have limited applicability and control. Specifically, the fuel injection apparatus may only be applicable to liquid-fuel applications having a pump that delivers fuel to an accumulator. In addition, the fuel injection apparatus of the '497 patent may have limited ability to adjust fuel delivery parameters.

The disclosed fuel system is directed to overcoming one or more of the problems set forth above and/or other problems of the prior art.

### SUMMARY

In one aspect, the present disclosure is directed to a fuel system for an engine having a plurality of cylinders. The fuel system may include a fuel supply, and a fuel distributor configured to selectively connect the fuel supply with the plurality of cylinders. The fuel system may also include a fuel valve fluidly connected between the fuel supply and the fuel distributor. The fuel valve may be movable to affect a fueling parameter of individual cylinders of the plurality of cylinders.

In another aspect, the present disclosure is directed to a method of distributing fuel to a plurality of cylinders within an engine. The method may include generating a flow of pressurized fuel within a common passage, and selectively restricting the flow of pressurized fuel through the common passage. The method may also include selectively communicating the common passage with fewer than all of a plurality of individual fuel lines leading to the plurality of cylinders.

### BRIEF DESCRIPTION OF THE DRAWING

FIG. 1 is a diagrammatic and schematic illustration of an engine having an exemplary disclosed fuel system.

### DETAILED DESCRIPTION

FIG. 1 illustrates an exemplary combustion engine 10. For the purposes of this disclosure, engine 10 is depicted and described as a two-stroke, gaseous-fueled engine, for example a natural gas engine. One skilled in the art will recognize, however, that engine 10 may be another type of combustion engine such as, for example, a two- or four-stroke gasoline or a diesel engine. Engine 10 may include an engine block 12 that at least partially defines one or more cylinders 14. A piston 16 may be slidably disposed within each cylinder 14 to reciprocate between a top-dead-center (TDC) position and a bottom-dead-center (BDC) position, and a cylinder head 18 may be associated with each cylinder 14. Cylinder 14, piston 16, and cylinder head 18 may together define a combustion chamber 20. It is contemplated that engine 10 may include any number of combustion chambers 20 and that combustion chambers 20 may be disposed in an “in-line” configuration, in a “V” configuration, in an opposing-piston configuration, or in any other suitable configuration.

Engine 10 may also include a crankshaft 22 that is rotatably disposed within engine block 12. A connecting rod 24 may connect each piston 16 to crankshaft 22 so that a sliding motion of piston 16 between the TDC and BDC positions within each respective cylinder 14 results in a rotation of crankshaft 22. Similarly, a rotation of crankshaft 22 may result in a sliding motion of pistons 16 between the TDC and BDC positions. As crankshaft 22 rotates through about 180 degrees (i.e., as crankshaft 22 moves through one-half of its rotation), each piston 16 may move through one full stroke between BDC and TDC. Engine 10, being a two-stroke engine, may have a complete cycle that includes a power/exhaust/intake stroke (TDC to BDC) and an intake/compression stroke (BDC to TDC). In a four-stroke engine (alternative embodiment—not shown), piston 16 may reciprocate between the TDC and BDC positions during each of an intake stroke, a compression stroke, a combustion or power stroke, and an exhaust stroke for every complete engine cycle or two full rotations of crankshaft 22.

During a final phase of the power/exhaust/intake stroke described, air may be drawn into combustion chamber 20 via one or more air intake ports 26 located within a sidewall of each cylinder 14 (e.g., within a liner of each cylinder 14). In particular, as piston 16 moves downward within cylinder 14, a position will eventually be reached at which air intake ports 26 are no longer blocked by piston 16 and instead are fluidly communicated with combustion chamber 20. When air intake ports 26 are in fluid communication with combustion chamber 20 and a pressure of air at air intake ports 26 is greater than a pressure within combustion chamber 20, air will pass through air intake ports 26 into combustion chamber 20.

Gaseous fuel (e.g., methane or natural gas), may be introduced into combustion chamber 20 (e.g., radially injected) through at least one of air intake ports 26. The gaseous fuel may mix with the air to form a fuel/air mixture within combustion chamber 20. Eventually, piston 16 will start an upward movement that blocks air intake ports 26 and compresses the air/fuel mixture. As the air/fuel mixture within combustion chamber 20 is compressed, a temperature and pressure of the mixture may increase and, at a point when piston 16 is near TDC, the air/fuel mixture may ignite. This ignition may result in a release of chemical energy in the form of temperature and pressure spikes within combustion chamber 20.

During a first phase of the power/exhaust/intake stroke, the pressure spike within combustion chamber 20 may force piston 16 downward, thereby imparting mechanical power to crankshaft 22. At a particular point during this downward travel, one or more exhaust ports (not shown) located within cylinder head 18 (or elsewhere) may open to allow pressurized exhaust within combustion chamber 22 to exit and the cycle will restart.

Engine 10 may be equipped with a fuel system 30 having components that cooperate to deliver gaseous fuel to air intake port(s) 26 of each cylinder 14. Fuel system 30 may include, among other things, at least one fuel injector 32 located at one or more of the air intake ports 26 of each cylinder 14, a gaseous fuel supply 34, a fuel distributor 36, a control valve 38, and a controller 40 in communication with fuel distributor 36 and control valve 38. Fuel distributor 36 may communicate with all fuel injectors 32 via individual fuel lines 42, and with supply 34 via a common supply passage 44. Control valve 38 may be disposed within common supply passage 44 and movable based on signals from controller 40 to selectively restrict the flow of gaseous fuel through passage 44.

In one embodiment, each fuel injector 32 may be positioned adjacent the liner of a corresponding cylinder 14 at a particular air intake port 26, such that a nozzle of fuel injector 32 is in direct communication with combustion chamber 20 via the air intake port 26. In another embodiment, one or more fuel injectors 32 may indirectly communicate with combustion chamber 20, for example, via a recess or cavity that functions as a distribution and/or mixing manifold at air intake ports 26. In either embodiment, fuel injector 32 may be a non-controlled fuel injector that simply functions to direct or funnel the gaseous fuel to a particular location.

Fuel supply 34 may represent a fuel tank or other container (e.g., a pressurized cylinder) suitable to serve as a reservoir for fuel. The fuel may be held within supply 34 in gaseous or liquid form, as desired. If held as a liquid, the fuel within supply 34 may first be gasified before being directed into common supply passage 44. Gasification may occur through a change in pressure and/or application of heat to the fuel.

Fuel distributor 36 may be controllably activated to selectively connect common supply passage 44 with one or more particular fuel lines 42. In the disclosed embodiment, fuel distributor 36 is a rotary distributor having a valve element 46 connected to and driven by a linear actuator 48. Linear actuator 48 may be pivotally connected to a periphery of valve element 46 and, through extension and retraction thereof, cause valve element 46 to rotate about a central pivot point. Valve element 46 may have an inlet and any number of outlets, and be selectively rotated by linear actuator 48 to establish one or more desired (and simultaneous) connections between common supply passage 44 and fuel lines 42. The extension and retraction of linear actuator 48 may be regulated by controller 40. It is contemplated that, although a particular embodiment of fuel distributor 36 has been shown in FIG. 1 and described in detail, fuel distributor 36 may take any conventional form known in the art. It is important to note, however, that the disclosed embodiment may allow connection between common supply passage 44 and any number of individual fuel lines 42, in any order, and at any timing relative to the rotation of crankshaft 22 and the reciprocating movement of pistons 16.

Control valve 38 may be a solenoid-operated valve having a valve element movable to any position between a first position and a second position. When the valve element is in the first position, flow through common supply passage 44 may be inhibited. When the valve element is in the second position, flow through common supply passage 44 may be substantially unrestricted by control valve 38. When the valve element is in an intermediate position (i.e., a position between the first and second positions), the flow of fuel through common supply passage 44 may be restricted to a corresponding degree. The valve element of control valve 38 may be biased toward the first position and movable toward the second position based on a signal from controller 40.

Controller 40 may embody a single or multiple microprocessors, field programmable gate arrays (FPGAs), digital signal processors (DSPs), etc., that include a means for controlling an operation of fuel system 30 in response to signals received from one or more sensors 50. Numerous commercially available microprocessors can be configured to perform the functions of controller 40. It should be appreciated that controller 40 could readily embody a general engine microprocessor capable of controlling numerous system functions and modes of operation. Various other known circuits may be associated with controller 40, including power supply circuitry, signal-conditioning circuitry, actuator driver circuitry (i.e., circuitry powering solenoids, motors, or piezo actuators), communication circuitry, and other appropriate circuitry.

Sensor 50 may be configured to generate a signal indicative of an engine performance parameter. In one example, the engine performance parameter may be associated with a speed of engine 10. For example, sensor 50 may be disposed proximal to crankshaft 22, and configured to measure and generate a signal indicative of an instantaneous angular position of crankshaft 22. Based on a change in this position relative to time, a speed of engine 10 may be derived. The position information may also or alternatively be used to determine the positions of pistons 16. Based on the engine speed and/or piston positions, controller 40 may be configured to determine a timing at which fuel should be injected into combustion chamber 20 and/or a quantity of fuel that should be injected. Controller 40 may then selectively activate linear actuator 48 to connect common fuel passage 44 with a particular one or more of individual fuel lines 42 and also move the valve element of control valve 38 to a particular position corresponding with a desired quantity of fuel to be injected. It is contemplated that controller 40 may activate linear actuator 48 and move the valve element of control valve 38 in any order and at any time, or even simultaneously, if desired.

### INDUSTRIAL APPLICABILITY

The disclosed fuel system may be applicable to any combustion engine where uniform control over separate fuel injection events is desired. The disclosed fuel system may be particularly applicable to a two-stroke, gaseous-fueled engine. Fuel system 30 may help reduce cylinder-to-cylinder fueling variation by using a single injector to inject gaseous fuel at a single location upstream of an associated fuel distributor. The fuel distributor may then help to uniformly deliver the fuel to select cylinders of the engine. Operation of fuel system 30 will now be described in detail.

During a downward portion of an associated piston intake stroke, a low-pressure condition may be generated within each of combustion chambers 20. This low-pressure condition may function to draw air through intake ports 26 into combustion chambers 20. Depending on the location of combustion chambers 20 within engine block 12, this action may be performed within different combustion chambers 20 at different times relative to the rotation angle of crankshaft 22. In some embodiments, multiple combustion chambers 20 may be paired to move through the same piston strokes simultaneously.

During the same or another portion of the intake stroke, fuel may be directed into a particular one or more combustion chambers 20 (e.g., into the combustion chamber 20 located second from the left in FIG. 1) at a desired timing and in a desired amount. Specifically, pressurized fuel from supply 34 may enter common supply passage 44, be regulated by controller 40 via control valve 38 to a desired flow rate and/or pressure, and communicated with fuel distributor 36. Controller 40 may then selectively activate linear actuator 48 to rotate valve element 46 until a desired connection between common supply passage 44 and one or more particular fuel lines 42 is established, thereby allowing the injected fuel to flow into desired combustion chambers 20 via injectors 32 and air intake ports 26. The desired fuel timings and/or injection amounts may be determined, at least partially, based on signals from sensor 50.

Following the intake stroke, crankshaft 22 may cause pistons 16 to move through an ensuing upward compression stroke. As piston 16 moves upward, from the BDC position towards the TDC position during the compression stroke, the fuel and air within combustion chambers 20 may be mixed and compressed. At a time during the compression stroke or, alternatively, just after completion of the compression stroke, combustion of the compressed mixture may be initiated. This combustion may force pistons 16 back toward the BDC position, thereby causing pistons 16 to drive the rotation of crankshaft 22.

It will be apparent to those skilled in the art that various modifications and variations can be made to the disclosed fuel system. Other embodiments will be apparent to those skilled in the art from consideration of the specification and practice of the disclosed fuel system. It is intended that the specification and examples be considered as exemplary only, with a true scope being indicated by the following claims and their equivalents.

What is claimed is:

1. A fuel system for an engine having a plurality of cylinders, the fuel system comprising:
a fuel supply;
a fuel distributor configured to selectively connect the fuel supply with the plurality of cylinders; and
a fuel valve fluidly connected between the fuel supply and the fuel distributor, the fuel valve movable to affect a fueling parameter of individual cylinders of the plurality of cylinders.

2. The fuel system of claim 1, wherein the fuel supply is a supply of gaseous fuel.

3. The fuel system of claim 1, wherein the fuel distributor is configured to supply each of the plurality of cylinders with fuel from the fuel supply during every other stroke of an associated piston.

4. The fuel system of claim 1, wherein:
each of the plurality of cylinders includes a plurality of annularly-arranged inlet ports formed within a corresponding cylinder liner; and
the fuel system further includes at least one fuel injector disposed within at least one of the plurality of annularly-arranged inlet ports.

5. The fuel system of claim 4, further including a plurality of individual fuel lines extending from the fuel distributor to the at least one fuel injector associated with each of the plurality of cylinders.

6. The fuel system of claim 5, wherein the fuel distributor is a rotary distributor having a valve element that rotates between the plurality of individual fuel lines.

7. The fuel system of claim 6, further including a linear actuator connected with the valve element and configured to rotate the valve element.

8. The fuel system of claim 1, further including a controller in communication with the fuel valve.

9. The fuel system of claim 8, wherein the controller is in further communication with the fuel distributor.

10. The fuel system of claim 8, further including a sensor configured to generate a signal indicative of a performance parameter of the engine, wherein the controller is configured to regulate movement of the fuel valve based on the signal.

11. The fuel system of claim 10, wherein the sensor is a crank angle sensor.

12. A method of distributing fuel to a plurality of cylinders within an engine, comprising:
generating a flow of pressurized fuel within a common passage;
selectively restricting the flow of pressurized fuel through the common passage; and
selectively communicating the common passage with fewer than all of a plurality of individual fuel lines leading to the plurality of cylinders.

13. The method of claim 12, wherein the fuel is a gaseous fuel.

14. The method of claim 13, wherein selectively restricting the flow of pressurized fuel includes selectively moving a valve element to open and close the common passage between a supply of the gaseous fuel and a rotary fuel distributor.

15. The method of claim 13, wherein selectively communicating the common passage with fewer than all of a plurality of individual fuel lines includes selectively communicating the common passage with each of the plurality of individual fuel lines once for every two crankshaft rotations of the engine.

16. The method of claim 13, further including directing fuel from the plurality of individual fuel lines through air inlet ports annularly arranged within each of the plurality of cylinders.

17. The method of claim 13, wherein selectively communicating the common passage with fewer than all of a plurality of individual fuel lines includes rotating a valve element to communicate the common passage with a single one of the plurality of individual fuel lines at a time.

18. The method of claim 17, wherein rotating the valve element includes energizing a linear actuator to cause the valve element to rotate.

19. The method of claim 13, further including sensing a performance parameter of the engine, wherein selectively restricting and selectively communicating are performed based on a sensed value of the performance parameter.

20. An engine, comprising:
an engine block at least partially defining a plurality of cylinders each having a plurality of annularly-arranged air inlet ports;
a piston reciprocatingly disposed within each of the plurality of cylinders;
at least one fuel injector disposed within at least one of the annularly arranged inlet ports of each of the plurality of cylinders;
a rotary fuel distributor;
a plurality of individual fuel lines extending from the rotary fuel distributor to the at least one fuel injector associated with each of the plurality of cylinders;
a supply of gaseous fuel;
a fuel valve disposed within a common passage extending between the supply and the rotary fuel distributor; and
a controller in communication with the fuel valve and the rotary fuel distributor, the controller configured to selectively regulate operation of the fuel valve and the rotary fuel distributor.
